(19) United States
(12) Patent Application Publication
(10) Pub. No.: US 2012/0303614 A1
(43) Pub. Date: Nov. 29, 2012

(54) AUTOMATING RESPONSES TO INFORMATION QUERIES

(75) Inventors: Marc E. Mercuri, Bothell, WA (US); James O. Tisdale, Duvall, WA (US)

(73) Assignee: MICROSOFT CORPORATION, Redmond, WA (US)

(21) Appl. No.: 13/113,087

(22) Filed: May 23, 2011

(51) Int. Cl. G06F 17/30

(52) U.S. Cl. 707/723; 707/E17.014

(57) ABSTRACT

An automated response system is described herein that allows users to submit information queries in a format they are comfortable with while unburdening other users from answering redundant or automatically answerable queries in forums such as email distribution lists. The system provides an email-based smart question and answer system that can be added to existing email or collaboration software to provide automatic replies to common questions. The system can be integrated at a level that prevents such queries from ever reaching other members of the list or can be setup like any other member of the list, receiving and processing queries as they are distributed to list members. Members can vote on responses and the system can automatically use past votes on answers to a question to provide the highest rated answers in response to similar future queries.

### BACKGROUND

People are constantly faced with the task of finding information. From directions, to instructions for performing an activity, to basic facts (where's a gas station near here?), people look for information all the time. Organizations such as large companies often provide large information systems for providing answers to questions. For example, a company may maintain a database of common information, provide training materials for disseminating information, provide public folders in a messaging system, provide distribution lists and other forms of communication, and so forth. The Internet has added new sources of information, including search engines.

Distribution lists have existed for a long time for users of computer systems to send messages to a group of people and to allow distributed (in both time and geography) discussion. Distribution lists exist publicly on the Internet centered around a variety of topics, such as politics, lists for professional organizations and fields, user interest lists, and so on. Organizations also often provide distributions lists for people that work on the same team, are interested in a similar technology or organizational topic, or are associated in some other way. Organizations may also provide other means of using distribution lists in addition to email, such as connections to an instant messaging service that allow real-time distribution of messages to currently available members of the list.

At large companies a great deal of time is spent sending and answering emails. Despite numerous advancements in search and internal collaboration systems, often times the quickest way to find an answer is to quickly send an email to a large group of people (often on a distribution list) and hope someone knows or remembers the answer. It is common for members of a distribution list to become tired of redundant questions and to establish supplemental reading material (e.g., an associated document, wiki, or other information source) for new members of the list in an attempt to answer common questions before those questions make it to the list. Nevertheless, the high level of comfort most people have with email and the additional time involved in finding information elsewhere often lead to efforts to reduce redundant use of the distribution list being ineffective.

### SUMMARY

An automated response system is described herein that allows users to submit information queries in a format they are comfortable with while unburdening other users from answering redundant or automatically answerable queries. There is an opportunity through the above system to enable people to continue to use email (the tool of choice) in seeking answers but to automate the response for common questions in a return email that derives answers from those voted on by the group or another source. The automated response system provides an email-based smart question and answer system that can be added to existing email or collaboration software to provide automatic replies to common questions. The system can be integrated at a level that prevents such queries from ever reaching other members of the list or can be setup like any other member of the list, receiving and processing queries as they are distributed to list members. Members can vote on responses and the system can automatically use past votes on answers to a question to provide the highest rated answers in response to similar future queries. Thus, the system allows users to get fast responses to common questions, allows other (potentially new) members to also see highly rated responses, and unburdens existing members from answering previously answered common questions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the automated response system, in one embodiment.

FIG. 2 is a flow diagram that illustrates processing of the automated response system to provide an automated response to a query, in one embodiment.

FIG. 3 is a flow diagram that illustrates processing of the automated response system to receive a ranking of responses that may form the basis of future automated responses, in one embodiment.

### DETAILED DESCRIPTION

An automated response system is described herein that allows users to submit information queries in a format they are comfortable with while unburdening other users from answering redundant or automatically answerable queries. There is an opportunity through the above system to enable people to continue to use email (the tool of choice) in seeking answers but to automate the response for common questions in a return email that derives answers from those voted on by the group or another source. In some embodiments, the automated response system provides an email-based smart question and answer system that can be added to existing email or collaboration software to provide automatic replies to common questions. In some embodiments, the automated response system can be integrated at a level that prevents such queries from ever reaching other members of the list (e.g., answerable questions are intercepted and answered before posting to the list at large). For example, communication software like MICROSOFT™ TownHall provides the ability to link from existing email programs to ferry a question, have it queried in TownHall, and to reply with the highest rated response. Alternatively, the system can be setup like any other member of the list, receiving and processing queries as they are distributed to list members.

Answers can be provided in a variety of ways. For example, a list administrator or moderator may provide a list of commonly asked questions and a set of responses to provide upon detecting a similar question. Members may also vote on responses and the system can automatically use past votes on answers to a question to provide the highest rated (or N highest rated) answers in response to similar future queries. Suppose, as an example, that a user wants to determine great games for an eight-year old for the MICROSOFT™ XBOX™ game console. The user discovers a few distribution lists that might have an opinion, and sends an email with this question. The automated response system is a member of the distribution list. The system takes the question, and searches available information to determine an appropriate answer. There is a hit in the search results and the system sends the top-rated answer back with a link to the further information as an auto reply to the initial query. Thus, the system allows users to get fast responses to common questions, allows other (potentially new) members to also see highly rated responses, and unburdens existing members from answering previously answered common questions.

In some embodiments, the automated response system also captures answers and seeks verification from the group membership. For example, the system might observe responses to new questions (or all questions), and note keywords or other language that indicates that a response was helpful. Upon receiving a similar question in the future, the system can automatically reply with the previously helpful responses (e.g., in a digest or other format). Some users may voluntarily vote on responses through an interlace of the system for ranking answers. This allows the system to quantify the helpfulness of answers and their usefulness in response to future queries.

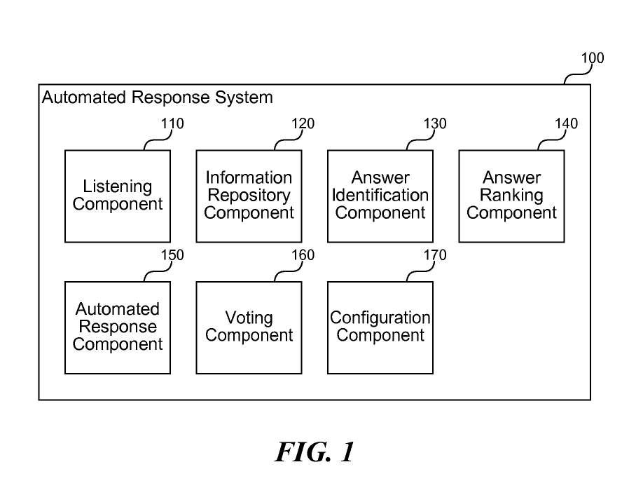

FIG. 1 is a block diagram that illustrates components of the automated response system, in one embodiment. The system 100 includes a listening component 110, an information repository component 120, an answer identification component 130, an answer ranking component 140, an automated response component 150, a voting component 160, and a configuration component 170. Each of these components is described in further detail herein.

The listening component 110 integrates with a communication system to listen for queries submitted to a communication list. For example, the listening component 110 may include an email inbox that is joined by an administrator as a member of an email distribution list, instant messaging group, contact list, or other communication list. Alternatively or additionally, the listening component 110 may be integrated in a particular communications system as a moderator that can intercept queries before they are distributed to the list. If the question can be answered by the system 100 in an automated fashion, then it may be unnecessary to post the query or answer to the list. After receiving an automated reply, the original requestor may be asked to indicate whether the reply answered the question, and if not the listening component 110 may allow the submitted question to be distributed to the list members for a non-automated answer.

The information repository component 120 stores knowledge derived from one or more prior questions and answers to provide automated responses to subsequent queries. The component 120 may include one or more files, file systems, hard drives, databases, cloud-based storage services, or other storage facilities for persisting various types of information, such as text or other responses. The component 120 may also include an associated website, such as a wiki or MICROSOFT™ SHAREPOINT™ site, that provides information related to a communications list. The automated response system 100 may provide links to the associated website in conjunction with automated responses to point inquirers to further sources of related information.

The answer identification component 130 identifies one or more answers available from the information repository component 120 that are related to a query detected by the listening component 110. The answer identification component 130 may identify answers by comparing query text to one or more queries associated with the answer, by analyzing keywords, by performing natural language processing (NLP), or other content analysis. The component 130 may retrieve more than one answer to provide the inquirer with multiple answers or to dynamically determine a rank of answers and provide the inquirer with the most suitable answer. In some cases, the system 100 receives supplemental information with a query that may make one answer more suitable for a particular user than another answer, and dynamic ranking allows the system 100 to choose on a per-user basis.

The answer ranking component 140 ranks the identified answers to determine one or more answers that are suitably responsive to the detected query. The component 140 may rank answers based on previously received user votes, based on responses from prior inquirers to a particular answer, based on supplemental information about the current inquirer (e.g., location, time, user characteristics, and so forth), or on any other basis determined by the system 100 implementer to be useful for a particular application of the system 100.

The automated response component 150 provides one or more top ranked answers as an automated reply to the detected query. Because of the speed of automated processing, in most cases the automated reply will precede any users' responses to the query. This allows other members of the communications list to determine that an automated response has been provided and to determine whether the response was sufficient. If not, other users may provide additional responses as well as providing voting information that rates the helpfulness of the automated response. This creates a feedback loop that improves the quality of automated responses over time. In instances where the automated response is sufficient, other list members can ignore the query and need not provide further responses.

The voting component 160 receives rating information that quantifies responsiveness of a previous response to a query. The previous response may have been an automated or user-provided one; the system 100 may allow users to rank both manual and automated responses. In this way, the system 100 can improve both its automated responses as well as recognizing user-provided responses for potential future automated action. The voting component 160 may include links within responses for convenient voting directly from a received response, as well as through a separate interface through which users can help train the system 100.

The configuration component 170 receives configuration information from administrators that determines modifiable behavior of the system 100. For example, the system 100 may include a confidence score that is determined for each potential answer and the administrator may configure a threshold score that is met before the system 100 provides an automated response. The system 100 may also include a training period and mode during which the system learns common queries and responses but does not yet provide responses until the administrator transitions the configuration from a training mode to an active mode. In some embodiments, the system 100 may allow individual users to configure whether they receive automated responses, or may allow administrators to define groups of users to watch for responses (e.g., high reputation users that are known to provide helpful information).

The computing device on which the automated response system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

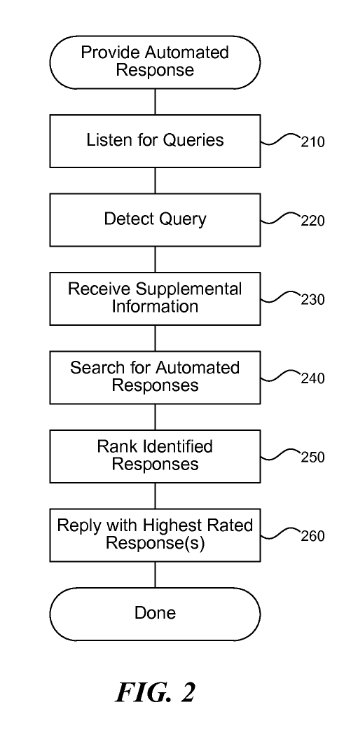

FIG. 2 is a flow diagram that illustrates processing of the automated response system to provide an automated response to a query, in one embodiment. Beginning in block 210, the system listens for queries sent to a communications list. For example, the system may operate as an automated moderator that receives submissions sent to a forum or distribution list, or as a member of the list that receives submissions like other members. Upon receiving a submission, the system determines whether the submission includes a request for information that the system can automatically answer or for which the system can provide leads to related information. The submission may be received through email, voice, text message, instant messaging, or any other mode of communication to which the system can listen and respond.

Continuing in block 220, the system detects a query in a received communication. For example, the system may process the submission to identify keywords, punctuation, or language features that indicate a request for information. The system may ignore some submissions that do not appear to be questions (e.g., answers to other queries) while responding to others.

Continuing in block 230, the system optionally receives supplemental information related to the detected query. For example, the system may capture information about the query submitter, such as the identity of the submitter, the submitters location (e.g., via global positioning system or other information available from the submitter's client device), and so forth. The received supplemental information may assist the system in selecting appropriate automated query responses specific to the submitter of the query.

Continuing in block 240, the system searches for an automated response to provide to the detected query by searching a knowledge base associated with the system. The knowledge base may include past questions and answers, responses from other users that were identified as helpful, information from the Internet related to the query, information from organizational resources (e.g., a corporate intranet) that are relevant, and so on. The system may gather potential responses from multiple sources and select which responses to send to the submitter in response to the detected query.

Continuing in block 250, the system ranks one or more identified responses discovered via the search to prioritize responses based on relevance. In some embodiments, the system uses the received supplemental information to rank responses in a manner that is specific to a particular user, query, device, or other criteria. Ranking helps to elevate responses that are most likely to be responsive to the user's query based on information available to the system. The system may also incorporate past user feedback to rank responses differently over time.

Continuing in block 260, the system replies to the detected query with one or more of the highest ranked responses. The system may reply by posting a reply to the communications list or by directly sending a message to the query submitter. In cases where the system intercepts queries before they hit the list, the system replies directly to the submitter and may inquire whether the submitter still wants to submit his query to the list for further responses. If the automated response sufficiently answered the query, the user may avoid sending the query to the entire list. This can prevent unneeded annoyance to list members and make the submitter look better by not posing redundant questions. After block 260, these steps conclude.

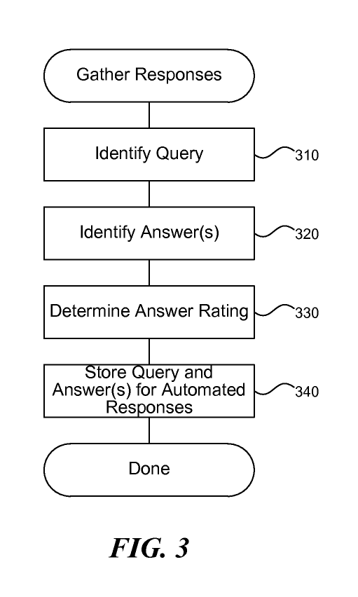

FIG. 3 is a flow diagram that illustrates processing of the automated response system to receive a ranking of responses that may form the basis of future automated responses, in one embodiment. Beginning in block 310, the system identifies a query made by a user to which one or more responses have been provided by other users. For example, the system may monitor a distribution list, forum, or other communication channel through which users communicate to find and distribute information to each other. The system identifies queries through textual analysis, manual identification by an administrator that informs the system of a query, or other method. For example, the system may provide an email address to which users can submit past questions that are suitable for having automated responses.

Continuing in block 320, the system identifies one or more answers provided to the identified query. For example, the system may identify threads of conversation in an email list or forum based on conversation identifiers, subject or text analysis, or other methods. The system may process text to determine which responses include substantive answers and which responses include further questions or non-responsive information (e.g., spam or inflammatory responses).

Continuing in block 330, the system determines a rating for each identified answer. The system may determine ratings through one or more interactive or automated processes. For example, the system may provide an interface through which users can rate responses to posted questions. The interface may include a web page, a link within each email posted to the communications list, or other interface for users to provide rating information. The system may also automatically determine the responsiveness of a particular answer, such as by analyzing users' reactions to the answer (e.g., the original query poster may answer “thanks” in response to a helpful answer) or based on the length or other characteristics of the response.

Continuing in block 340, the system stores the identified query, answers, and determined ratings in a knowledge base from which to provide a subsequent automated response upon detecting a similar query. For example, the system may store the questions and answers in a database. The system may also provide an interface through which users of the communications list can browse common questions and answers, such as a web page or email message that users can send to receive a response of frequently asked questions (FAQ). After block 340, these steps conclude.

In some embodiments, the automated response system provides automated responses through non-email modes of communication. For example, the system may provide a voice interface through a mobile application, telephone line, or other communication channel. Users can speak questions and receive either textual or speech answers. As another example, the system may respond to text messages (e.g., short message service (SMS)) or instant messaging.

In some embodiments, the automated response system provides a customer service frontend for a business. The system can act as a customer service frontend on a website or through another interlace, through which visiting users can ask questions such as technical support questions, billing questions, and so forth. The system may provide a first line of communication to sort customers based on their needs and handle those quickly that can be handled in an automated manner. The system may then forward those that are too difficult to a human attendant.

In some embodiments, the automated response system receives the user's location as supplemental information to a query. In some cases, user queries cannot be answered well without additional information. For example, if a user with a mobile device asks where a good barbeque restaurant is, the user likely wants to receive information about nearby restaurants. With the user's location, the system can provide more accurate and responsive answers.

In some embodiments, the automated response system receives feedback from the user that receives the automated response. For example, the system may include voting links within an automated email response that allow the recipient to indicate whether the response was helpful. The system may flag responses that receive low ratings for further review by a system administrator to provide answers that are more helpful. Likewise, the system may promote high rated answers as authoritative responses for a particular query.

In some embodiments, the automated response system builds a set of questions and responses based on past dialogs on a distribution list or other communication list. Users may vote on answers to questions and the system may store information about each question and how responses are rated. Upon identifying a similar question in the future, the system may provide the most helpful response or provide a link to the prior discussion or other information so that the latest user asking the question can benefit from answers of the past.

From the foregoing, it will be appreciated that specific embodiments of the automated response system have been described herein for purposes of illustration, but that various modifications may be made without deviating from the spirit and scope of the invention. Accordingly, the invention is not limited except as by the appended claims.

I/We claim:

1. A computer-implemented method for providing an automated response to a query, the method comprising:
listening for queries sent to a communications list;
detecting a query in a received communication sent to the communications list;
searching a knowledge base for an automated response to provide to the detected query;
ranking one or more identified responses discovered via the search to prioritize responses based on relevance; and
replying to the detected query with one or more of the highest ranked responses,
wherein the preceding steps are performed by at least one processor.

2. The method of claim 1 wherein listening for queries comprises operating as an automated moderator that receives submissions sent to the communications list before the submissions are sent to list members.

3. The method of claim 1 wherein listening for queries comprises joining as a member of the communications list to receive submissions like other members.

4. The method of claim 1 wherein listening for queries comprises, upon receiving a submission, determining whether the submission includes a request for information that the system can automatically answer.

5. The method of claim 1 wherein detecting the query comprises processing the received communication to identify language features that indicate a request for information.

6. The method of claim 1 wherein detecting the query comprises ignoring received communications that do not appear to be questions.

7. The method of claim 1 further comprising, after detecting the query, receiving supplemental information related to the detected query specific to the user that submitted the query and wherein ranking responses comprises applying the supplemental information to rank responses.

8. The method of claim 7 wherein the supplemental information includes information related to a current location of the user that submitted the query.

9. The method of claim 1 wherein searching the knowledge base comprises searching a database of past questions and answers to find any questions that match the current detected query and corresponding answers.

10. The method of claim 1 wherein searching the knowledge base comprises searching for past responses from other users of the communication list that were identified as helpful based on user voting.

11. The method of claim 1 wherein searching the knowledge base comprises gathering potential responses from multiple sources and selecting which responses to send to the submitter in response to the detected query.

12. The method of claim 1 wherein ranking responses comprises elevating responses that are most likely to be responsive to the user's query based on information available to the system.

13. The method of claim 1 wherein ranking responses comprises incorporating past user feedback to rank responses differently over time.

14. The method of claim 1 wherein replying to the detected query comprises posting a reply to the communications list.

15. A computer system for automating responses to information queries, the system comprising:
a processor and memory configured to execute software instructions embodied within the following components;
a listening component that integrates with a communication system to listen for queries submitted to a communication list;
an information repository component that stores knowledge derived from one or more prior questions and answers to provide automated responses to subsequent queries;
an answer identification component that identifies one or more answers available from the information repository component that are related to a query detected by the listening component;
an answer ranking component that ranks the identified answers to determine one or more answers that are suitably responsive to the detected query;
an automated response component that provides one or more top-ranked answers as an automated reply to the detected query; and
a voting component that receives rating information that quantifies responsiveness of a previous response to a query.

16. The system of claim 15 wherein the information repository component further comprises an associated website that provides information related to a communications list and wherein the system provides one or more links to the associated website in conjunction with automated responses to point inquirers to further sources of related information.

17. The system of claim 15 wherein the answer identification component identifies answers by comparing query text to one or more queries associated with the answer.

18. The system of claim 15 wherein the answer identification component identifies more than one answer to provide the inquirer with multiple answers or to dynamically determine a rank of answers and provide the inquirer with the most suitable answer.

19. The system of claim 15 wherein the voting component applies received rating information to improve the system's automated responses and to recognize highly rated user-provided responses for potential inclusion as future automated responses.

20. A computer-readable storage medium comprising instructions for controlling a computer system to receive a ranking of responses that may form the basis of future automated responses, wherein the instructions, upon execution, cause a processor to perform actions comprising:
identifying a query submitted by a user to which one or more responses have been provided by other users;
identifying one or more answers provided to the identified query by other users;
determining a rating for each identified answer that quantifies the responsiveness of the identified answer to the identified query; and
storing the identified query, answers, and determined ratings in a knowledge base from which to provide a subsequent automated response upon detecting a similar query.
